(19) United States
(12) Patent Application Publication
(10) Pub. No.: US 2009/0003666 A1
(43) Pub. Date: Jan. 1, 2009

(54) System and methods for image analysis and treatment

(76) Inventor: Dee H. Wu, Edmond, OK (US)

Correspondence Address: DUNLAP CODDING, P.C., PO BOX 16370, OKLAHOMA CITY, OK, 73113, US

(21) Appl. No.: 11/823,176

(22) Filed: Jun. 27, 2007

(51) Int. Cl. G06K 9/00

(52) U.S. Cl. 382/128

(57) ABSTRACT

An image analysis system comprising a computer apparatus programmed to access at least one image of tissue within a living organism and to register a plurality of segments of a region of interest of the tissue, the plurality of segments divided relative to a biological landmark of the living organism and/or each of the plurality of segments positionally referenced to the biological landmark, the computer apparatus further programmed to analyze at least one parameter for at least one of the plurality of segments. In another embodiment, the image analysis system further comprises an image recording apparatus for capturing the at least one image. In yet another embodiment, the image analysis system further comprises a treatment apparatus for delivering at least one type of therapy to at least a portion of at least one of the plurality of segments in relation to the position of the at least one segment relative to the biological landmark, in relation to the at least one parameter, or in relation to a combination of the two. In addition, methods of operating the image analysis system are provided, as well as methods of delineating a region of interest in an image, analyzing at least one image, and treating a region of interest.

### CROSS-REFERENCE TO RELATED APPLICATIONS

The present patent application claims benefit of provisional patent application No. 60/816,386, filed on Jun. 27, 2006, the entire content of which is hereby incorporated herein by reference

### STATEMENT REGARDING FEDERALLY-SPONSORED RESEARCH AND DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE OR A COMPUTER PROGRAM LISTING APPENDIX SUBMITTED ON A COMPACT DISC AND AN INCORPORATION-BY-REFERENCE OF THE MATERIAL ON THE COMPACT DISC (SEE §1.52(E)(5))

Not applicable.

### BACKGROUND OF THE INVENTION

1. Field of the Invention

The present invention relates generally to analyzing images. More specifically, but not by way of limitation, the present invention relates to analyzing images of tissue of a living organism, such as to tailor or otherwise improve medical treatment for the organism; and/or to deliver medical treatment in response thereto.

2. Discussion of Related Art

Images of tissue have long been used in the medical and veterinary fields to examine tissues of living organism to diagnose problems and treat such problems. Examples of such imaging include x-rays, computer tomographic (CT) images, images generated by magnet resonance imaging (MRI), images generated by ultrasonic techniques, and the like.

One example of a field in which such images are utilized is diagnosis and treatment of cancer. Dynamic contrast enhanced (DCE) MRI images have been used to identify cancerous tissues such that treatment can be targeted to such cancerous tissues. DCE-MRI imaging methods are well known in the art, but generally involve, injecting an organism with a contrast agent and obtaining a series of MRI images of tissue. As it is absorbed by various tissues within the body, the contrast agent enhances the contrast between and within neighboring tissues such that tissues absorbing relatively more contrast agent are distinguished, on the resulting MRI image, from tissues absorbing relatively less contrast agent. By capturing a series of images over time, differences between the DCE-MRI images reflect the rates at which tissues absorb and release the contrast agent, and can be used to analyze various parameters indicative of tissue and/or tumor vascularity, rates of perfusion, and the like.

In use, a series of DCE-MRI images are captured of tissue on or within an organism. Identification of a region of interest of tissue in an image is generally completed manually by a trained user. Some efforts have been made to automate this identification with computer algorithms that analyze variations between adjacent pixels to identify a boundary of the region of interest. Previous attempts at automating this identification have focused on local analysis between adjacent pixels of the image. However, such local analysis can retain errors in the image gathering process, such as equipment noise, low signal-to-noise ratios, environmental noise, physiological noise, such as is caused by breathing and pulse, and other sources of error. Thus, a need exists for systems and methods of improving the identification of a region of interest in an image by analyzing one or more parameters for the region of interest within an initial boundary, and comparing changes in the one or more parameters caused by adjustments to the initial boundary, so as to optimize the identification of the region of interest.

In prior methods, once the region of interest is properly identified, one or more parameters are calculated that are indicative of tissue and/or tumor vascularity, angiogenesis, rates of perfusion, or the like. The one or more parameters can then be used to tailor the level or amount of a type of therapy delivered to the tumor. Types of therapy may include radiation therapy (RT), chemotherapy, drug therapy, surgical therapy or the like.

Some attempts have been made in the prior art to examine the heterogeneity within such tumors. For example, methods are known for examining a region of interest, such as a tumor, in an image on an overall regional level, a pixel-by-pixel level, or by analyzing a plurality of segments of the region of interest. Each of these has a variety of drawbacks. For example, analyzing an entire region of interest does not reflect any heterogeneity that may exist within the tumor. Analyzing a region of interest on a pixel-by-pixel level may retain additional levels of error, as discussed above.

Analyzing the region of interest in segments creates an advantageous compromise between the first two levels by eliminating or at least reducing error by analyzing the at least one parameter over an aggregate portion of the region of interest, while still recognizing potential heterogeneity between segments of the region of interest. However, in the past, segments of a region of interest have been examined without reference to any biological landmarks within the organism and/or have been randomly selected without reference to any biological landmark within the organism. Thus, a need exists for systems and methods for image analysis and treatment which permit a region of interest to be analyzed in segments, with each of the segments positionally referenced to, and/or the region of interest segmented in relation to, a biological landmark.

### BRIEF DESCRIPTION OF THE DRAWINGS

FIG. 1 is a pictorial diagram of one embodiment of an image analysis and treatment system constructed in accordance with the present invention.

FIG. 2 is a pictorial diagram of the lower portion of a human torso, illustrating a cancerous uterine tumor for which the systems and methods of the present invention may be used to analyze and treat.

FIG. 3 is an enlarged view of the uterus and uterine tumor of FIG. 2.

FIG. 4 is an enlarged view of the tumor of FIG. 3, depicting an iterative scheme for identifying a boundary of the uterine tumor.

FIG. 5 is an enlarged view of the uterine tumor of FIG. 3, depicting an exemplary segmentation scheme for analyzing the tumor.

FIG. 6 depicts an exemplary mean signal response distribution for the segmented tumor of FIG. 5, obtained using known DCE-MRI techniques.

FIGS. 7-10 depict various graphs indicating the results of an exemplary study conducted in accordance with the present invention.

### DETAILED DESCRIPTION OF EXEMPLARY EMBODIMENTS

### 1. System Overview

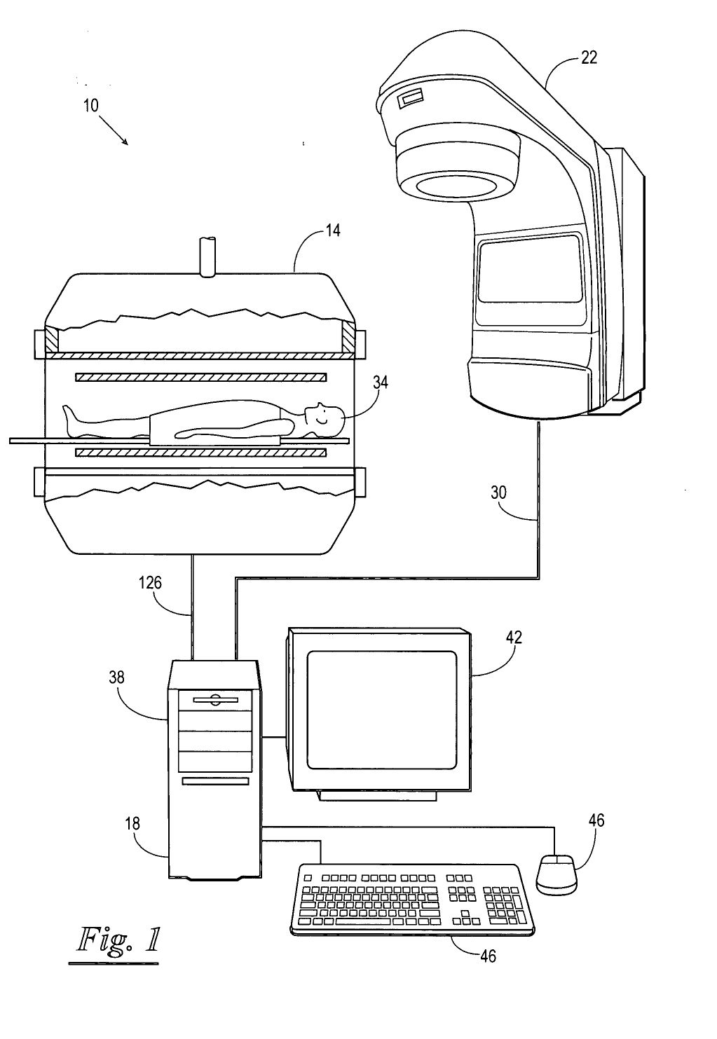

Referring now to the figures, and more particularly to FIG. 1 an image analysis and/or treatment system 10 is shown constructed in accordance with the present invention. The system 10 is preferably adapted to access an image of tissue of a living organism, to analyze a region of interest in segments, with each of the segments positionally referenced to, and/or the region of interest segmented in relation to, a biological landmark such as an organ, a portion of an organ, a blood vessel, a bone, or any other biologically significant point of reference within the organism, so as to enable more comprehensive understanding of, and tailoring of the delivery of at least one method of treatment for, at least one of the segments of the region of interest.

The system 10 preferably comprises an image recording apparatus 14, a computer apparatus 18, and a treatment apparatus 22. The computer apparatus 18 is preferably in communication with the image recording apparatus 14 and with the treatment apparatus 22, via communication paths 26 and 30, respectively. Although the communication paths 26 and 30 are shown as wired paths, the communication paths 26 may be any suitable means for transferring data, such as, for example, a LAN, modem link, direct serial link, or the like. Similarly, the communication paths 26 and 30 may be wireless links such as, for example, RF, Bluetooth, WLAN, infrared, or the like.

It should also be understood that the communication paths 26 and 30 may be direct or indirect, such that the data transferred therethrough may travel through intermediate devices (not shown) such as servers and the like. The communication paths 26 and 30 may also be replaced with a computer readable medium (not shown), such as a CD, DVD, flash drive, remote storage device, or the like. For example, data from the image recording apparatus 14 may be saved to a CD and the CD transferred to the computer apparatus 18. Similarly, for example, the computer apparatus 18 could output data to a remote storage device (not shown) that is in communication with both the computer apparatus 18 and the treatment apparatus 22, such that the treatment apparatus 22 could retrieve the data from the remote storage device.

The image recording apparatus 14 may be any suitable device capable of capturing at least one image of tissue on or within a living organism 34 and either storing or outputting the image. The image capturing apparatus 14 is preferably a magnetic resonance imaging (MRI) device utilized in conjunction with a contrast agent to obtain series of dynamic contrast enhanced (DCE) MRI images. One example of an appropriate MRI device is the MAGNETOM Vision 1.5T, preferably equipped with a T2 Turbo Spin Echo, available from Siemens Medical Solutions USA, Inc., 51 Valley Stream Parkway, Malvern, Pa. One example of a suitable contrast agent is Gadopentetate dimeglumenine (Gd). However, such DCE-MRI methods are well known in the art, and any suitable contrast agent may be employed. In other embodiments, the image recording apparatus 14 may be any suitable device, utilizing, for example, x-ray techniques, nuclear imaging techniques, computed tomographic (CT) techniques, ultrasonic techniques, MRI spectroscopy techniques, a positron emission tomographic (PET) techniques, and/or hybrid techniques, or the like. Hybrid techniques may include any combination of the imaging techniques listed above or any other imaging techniques suitable for implementation of the system 10. Although the organism 34 is shown as a human, the organism 34 may also be any animal or plant, so long as the organism 34 is alive at the time the image recording apparatus captures an image of tissue on or within the organism 34.

The image recording apparatus 14 preferably captures three-dimensional images at known times or time points. In other embodiments, the image recording apparatus may capture two-dimensional images as well. Similarly, two-dimensional images are also preferably captured at known times or time points, such that images may be temporally related to one another. As will be appreciated by those skilled in the art, two-dimensional images will preferably include a plurality of pixels of equal size, and three-dimensional images will preferably include a plurality of voxels, or volume-pixels, of equal size. In other embodiments, the pixels or voxels may be of unequal size, or may represent unequal amounts of tissue, such as in an oblique image, as long as the amount of tissue represented by a single pixel or voxel can be determined, such as from the position of the image recording device 14 relative to the tissue in the image.

In the event that two-dimensional images are captured, the image recording apparatus 14 preferably captures data pertaining to the third dimension such that the two-dimensional images can be spatially related to one another. As will be appreciated by those skilled in the art, a series of two-dimensional images or “slices” may be spatially related, either parallel, perpendicular, or otherwise, to one another and data interpolated therebetween to create a three-dimensional model or other representation of the region of interest. Such a three-dimensional model may be used to create, or may be in the form of, a three-dimensional image. The image recording apparatus 14 also preferably captures data pertaining to the time at which the image is captured such that images can be temporally related to one another as well.

The computer apparatus 18 may be any suitable device capable of accessing and analyzing at least one image of tissue within the living organism 34, such as those captured by the image recording apparatus 14. In the preferred embodiment, the computer apparatus 18 includes a central processing unit (CPU) 38, a display 42, and one or more input devices 46. The CPU 38 preferably includes a processor, random access memory (RAM), and non-volatile memory, such as a hard drive. The display 42 is preferably a tube monitor, plasma screen, liquid crystal display, or the like, but may be any suitable device for displaying or conveying information in a form perceptible by a user, such as a speaker, printer, or the like. The one or more input devices 46 may be any suitable device, such as a keyboard, a mouse, a stylus and touchscreen, or the like. In other embodiments, the display 42 and the input device 46 may be integrated, such as in a touchscreen or the like. In yet further embodiments, the CPU 38 may be remotely-located from the display 42 and input device 46. Similarly, the display 42 and input device 46 may be omitted entirely, such as, for example, in embodiments of the system 10 which are fully-automated, or otherwise do not require a user to interact with the computer apparatus 18. As will be described in more detail below, the computer apparatus 18 is preferably programmable to perform a plurality of automated and/or semi-automated functions to identify, segment, and/or analyze segments of a region of interest of tissue within the at least one image.

The treatment apparatus 22 may be any suitable means for delivering at least one type of therapy to at least one segment or portion of a region of interest. In the preferred embodiment, the treatment apparatus is a radiation therapy (RT) device capable of delivering radiation therapy (RT) in a targeted manner to a region of interest, such as a tumor, on or within the organism 34. In other embodiments, the treatment apparatus 22 may be any device, machine, or assembly capable of delivering any suitable type of therapy in a targeted manner, such as for example, radiation therapy, chemotherapy, drug therapy, surgical therapy, nuclear therapy, brachytherapy, heat therapy, laser therapy, or ultrasonic therapy. For example, the treatment apparatus 22 may deliver a targeted injection of a chemotherapy agent or another drug to at least one segment of a region of interest. Similarly, the treatment apparatus 22 may perform robotic surgery to explore, investigate, or remove at least a portion of the region of interest of the tissue. In yet further embodiments, the treatment apparatus 22 may be operated by, or work in conjunction with, a human surgeon, such as in laparoscopic surgery or similar techniques.

In other embodiments, the image recording apparatus 14 and the treatment apparatus 22 may be omitted, such that the system 10 includes the computer apparatus 18. In such an embodiment, the computer apparatus 18 would access the at least one image from either a memory device within, or in communication with, the computer apparatus 18, or from a computer readable medium such as a CD, DVD, flash drive, or the like. In another embodiment, the system 10 includes the computer apparatus 18 and the treatment apparatus 22, such that upon analyzing at least one image of a region of interest of tissue, the computer apparatus 18 transmits data to cause the treatment apparatus 22 to deliver at least one type of therapy to at least one segment of a region of interest. In yet another embodiment, the treatment apparatus 22 may be omitted, such that the system 10 includes the image recording apparatus 14 and the computer apparatus 18, such that the computer apparatus 18 may access and analyze at least one image captured by the image recording apparatus 14, and output the results of the analysis to a user, such as, for example, by way of the display 42, or by way of a computer readable medium, such as a CD, DVD, flash drive, or the like.

### 2. System Operation and Methods

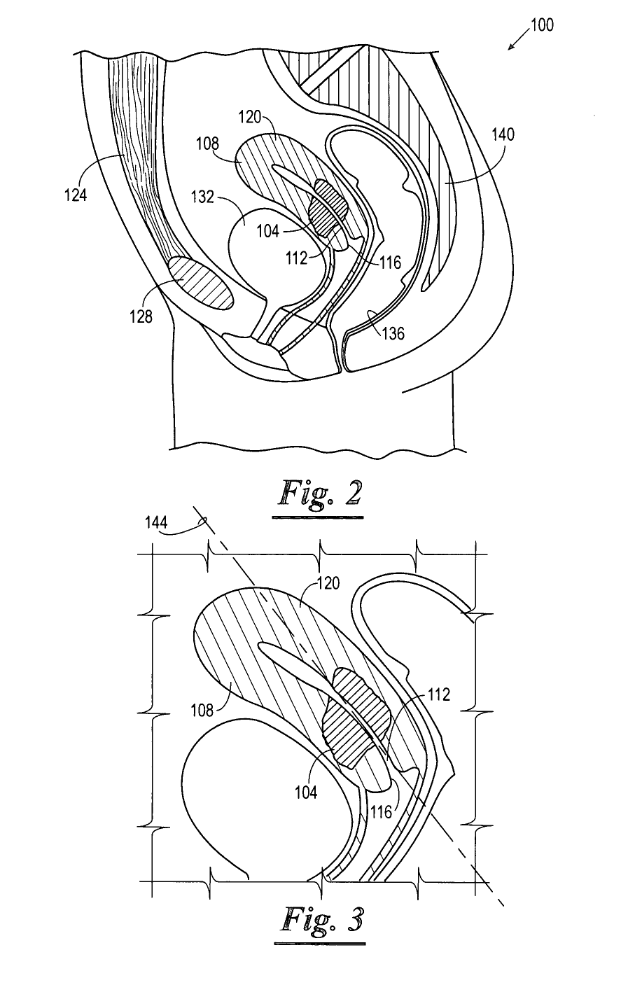

In use, the preferred embodiment of the system 10 functions, or is programmed to function, as follows. In accordance with standard DCE-MRE techniques, the organism 34 is injected with a known amount of contrast agent at a known injection rate. The image recording device 14 captures at least one image 100, as depicted in FIG. 2, and more preferably a plurality of images 100 at known times, of tissue within the living organism 34, for example, to pictorially capture several stages of relative absorption and release of the contrast agent by the tissue.

The computer apparatus 18 then accesses the at least one image 100, and preferably displays the at least one image 100 to a user, via the display 42. A region of interest 104, such as a tumor, is identified in the tissue of the image 100. Because the region of interest 104 is depicted as a tumor 104, these two terms may be used interchangeably hereinafter. However, it should be understood that the region of interest 104 may be nearly any region on or within a living organism 34 for which it is desirable to gain a greater understanding of, or deliver treatment to. Similarly, the region of interest 104 may be located on or within any living organism, such as, for example, a human, a cat, a dog, or the like.

By way of example, the tumor 104 is located in the uterus 108 more proximal to the uterine stripe 112 and the cervix 116, and more distal from the corpus 120 of the uterus 108. For clarity, the uterus 108 is shown in FIG. 2 in context of the lower portion of a female human torso, and also depicted are the abdominal muscles 124, the pubic bone 128, the bladder 132, the large intestine 136, and the tail bone 140.

Referring now to FIG. 3, an enlarged view of the region of interest 104 within the uterus 108 is shown. As mentioned above, it is desirable to positionally reference the region of interest 104 to a biological landmark of the organism 34. To this end, an axis 144 is preferably chosen to align with such a biological landmark and preferably to intersect an approximate center of volume of the tumor 104. The axis 144 is preferably identified or selected by a user, such as a doctor, a resident, a surgeon, a lab technician, or the like, and input into the computer apparatus 18, via the input device 46. In other embodiments, the computer apparatus 18 (FIG. 1) may be programmed to automatically place the axis 144 to correspond with one or more of a plurality of predetermined biological reference points within a body, such as bones, portions of bones, organs, portions of organs, glands, blood vessels, nerves, or the like.

In the example shown, the axis 144 is aligned with the uterine stripe 112 so as to extend from the cervix 116 in the direction of the corpus 120 of the uterus 108. This orientation is especially advantageous for analysis of a tumor 104 in the uterus 108 due to the differences in circulation between the corpus 120 and the cervix 116, which can result in heterogeneity of vascularity and perfusion rates within different portions of the tumor 104. The axis 144 positionally references the tumor 144 to the uterus 108, and thereby the uterine stripe 112, the cervix 116 and the corpus 120.

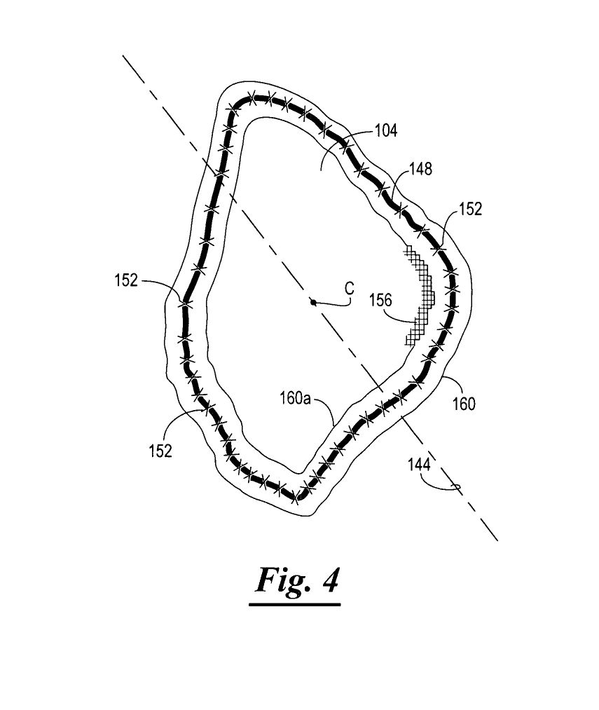

As best shown in FIG. 4, the tumor 104 must be identified with particularity, that is, delineated from other tissues within the image 100 (FIG. 2). This identification is preferably accomplished by the following steps. A user manually identifies an initial boundary 148 by identifying a plurality of vertices 152, via the input device 46, which are preferably displayed to the user along with the at least one image 100, via the display 42. In other embodiments, the initial boundary 148 may be identified by the computer apparatus 18, by any suitable automated or semi-automated method, for example, by recognizing and differentiating colors, shades, or relative contrast levels of, or between, adjacent pixels or voxels 156. As discussed above, the at least one image 100 preferably comprises of a plurality of voxels 156, only a portion of which are depicted for clarity. As also discussed above, if the image 100 is two-dimensional, the image 100 will comprise a plurality of pixels 156, rather than voxels. Thus, the initial boundary 148, and any other boundaries, will be digital, that is, will fall between adjacent pixels 156, as shown.

Once the initial boundary 148 is identified, that is, the user is satisfied that the initial boundary 148 closely or approximately delineates the tumor 104 or the computer apparatus 18 has completed an initial automated delineation, so as to identify an initial boundary 148. It will be appreciated by those skilled in the art that the foregoing method of identifying an initial boundary 148 may be repeated for each of a plurality of two-dimensional images 100 such that the computer apparatus 18 may interpolate between the plurality of two-dimensional images 100 so as to form a three-dimensional model or image of the tumor 148.

Similarly, in the case of a three-dimensional image 100, it may be desirable, especially for manual selection of an initial boundary 148, to select an initial boundary 148 for each of a plurality of slices of the three-dimensional images 148, such that the computer apparatus 18 can interpolate between the plurality of slices to form a three-dimensional initial boundary 148 for the entire three-dimensional image 100. In some embodiments, the computer apparatus 18 may be programmed to “learn” from the manual identification of the initial boundary in one or more individual slices of a three-dimensional image, model, or other representation, or in one or more two-dimensional images; such as by recognizing the difference in relative contrast, color, shade, or the like between adjacent pixels on opposite sides of the manually-identified initial boundary, so as to essentially mimic the manual identification of the user. In such a way, the computer apparatus 18 can more accurately re-create the manual identification of the initial boundary 148 on one or more slices so as to more accurately identify a three-dimensional initial boundary around and/or between the one or more slices.

In the preferred embodiment, the computer apparatus 18 then registers the resulting three-dimensional initial boundary 148, and calculates an initial region value indicative of the size of the region within the initial boundary, such as, for example, the volume within the initial boundary 148, or any other value indicative of the size of the region within the initial boundary 148. In other embodiments the computer apparatus 18 will preferably calculate the initial region value in another suitable form, for example, the area within the initial boundary 148, in the case of a single two-dimensional image; the areas within a plurality of initial region boundaries 148, in the case of a plurality of two-dimensional images; the volume within a plurality of initial boundaries 148, in the case of a plurality of two-dimensional images interpolated to form a three-dimensional model or image; or the like.

The computer apparatus 18 preferably then analyzes at least one parameter for the region within the initial boundary 148. The at least one parameter analyzed may be any useful parameter. The parameter may be any anatomical, functional, or molecular parameter that may assist in evaluating the region of interest, such as by indicating metabolic activity or the like. For example, when the region of interest is a tumor 104, the parameter may be a parameter indicative of tumor vascularity, perfusion rate, or the like. It is most preferable to select at least one parameter that is also useful in distinguishing the region of interest from surrounding tissues. For example, the tissue of a tumor 104 will generally exhibit different perfusion characteristics than the surrounding healthy tissue. Thus, a parameter indicative of perfusion will generally assist in distinguishing the tumor 104 from surrounding tissues.

One example of a parameter recognized in the art as indicative of perfusion rate in a tumor 104 is commonly known as k₁₂. Tumor perfusion is often studied with what is known as a pharmacokinetic “two-tank” model, with the tissue surrounding the tumor represented by a first tank and the tissue of the tumor represented by the second tank. k₁₂ is simply a parameter indicative of the rate at which the tissue of the tumor 104 absorbs the contrast agent from the surrounding tissue. As will be appreciated by those skilled in the art, such parameters may also be modeled with pharmacokinetic models having more than two tanks, for example, three, four, or the like. Because k₁₂ is only one example of a suitable parameter, and because such modeling, and specifically the k₁₂ parameter, is well known in the art, no further description of the at least one parameter is deemed necessary to enable implementation of the various embodiments of the present invention. Other parameters that may be used include k₂₁, amplitude, relative signal intensity (RSI), other pharmacokinetic parameters, VEGF, or the like.

After the at least one parameter is analyzed for the region within the initial boundary 148, the initial boundary 148 is adjusted so as to identify an adjusted boundary 160. The initial boundary 148 is preferably adjusted outward or inward by a predetermined amount, such as by offsetting the initial boundary 148 a pre-determined distance, or by offsetting the initial boundary 148 so as achieve a pre-determined change in volume or area of the region within the initial boundary 148. In other embodiments, the initial boundary 148 may be adjusted manually to identify the adjusted boundary 160, or in any other manner which may directly or indirectly assist a user or the computer apparatus in analyzing or evaluating the accuracy of the initial boundary 148 or in ascertaining a more accurate boundary, e.g. 148 or 162, of the tumor 104.

After the adjusted boundary 160 is identified, the computer apparatus 18 preferably calculates a region difference indicative of the change in size between the initial boundary 148 and the adjusted boundary 160. The computer apparatus 18 then preferably analyzes the at least one parameter for the region within the adjusted boundary 160 such that the at least one parameter for the initial boundary 148 can be compared to the at least one parameter for the adjusted boundary 160 and the change therebetween can be compared to the region difference to assist in determining whether the adjusted boundary 160 is more or less accurate than the initial boundary 148, or to assist in otherwise evaluating the accuracy of a boundary, e.g. 148 or 160, of the tumor 104.

For example, when the k₁₂ parameter is analyzed and compared for both boundaries 148 and 160, a large decrease in k₁₂ for a given region difference, i.e. change in size from the initial boundary 148 to the adjusted boundary 160, may indicate that a significant amount of non-cancerous tissue is included in the adjusted boundary 160. Such a result would indicate to either a user or to the computer apparatus 18 that the adjusted boundary 160 should be adjusted inward toward the initial boundary 148 and the k₁₂ parameter re-analyzed and re-compared to the k₁₂ parameter for the initial boundary 148.

Similarly, the initial boundary 148 can be adjusted inward to identify an adjusted boundary 160a, and the process of analyzing the at least one parameter for the adjusted boundary 160a and comparing the at least one parameter for the adjusted boundary 160 and the at least one parameter for the initial boundary 148 performed, as described above, for the adjusted boundary 160a. For example, when the k₁₂ parameter is analyzed and compared for both boundaries 148 and 160a, a large increase in k₁₂ for a given region difference, i.e. change in size from the initial boundary 148 to the adjusted boundary 160a, may indicate that a significant amount of non-cancerous tissue is included in the initial boundary 148. Such a result would indicate to either a user or to the computer apparatus 18 that the initial boundary 148 should be adjusted inward toward the adjusted boundary 160a and the k₁₂ parameter re-analyzed and re-compared to the k₁₂ parameter for the adjusted boundary 160a.

The parameter for the initial and adjusted boundaries 148,160, and 160a can then be compared to a reference to assist in evaluating the accuracy of the delineation of the tumor. For example, the reference could be an acceptable limit on the change in k₁₂, i.e. 5%, such that when a given region difference results in a parameter difference greater than 5%, the process can be repeated with an adjusted boundary 160 or 160a that is closer to the initial boundary 148. The reference could also be generated by an evaluation of the at least one parameter for a number of adjusted boundaries 160 and/or 160a such that a curve can be fit to the data and the reference could be a sharp change in slope of the data or any other deviation that may be indicative of the accuracy of any of the boundaries 148, 160, and/or 160a. In yet further embodiments, the reference could be a predetermined limit on the permissible parameter difference per unit volume change.

The parameter difference may be compared to the reference either manually or in automated fashion, and may be compared either in absolute, relative, normalized, quantitative, qualitative, or other similar fashion. A positive comparison is indicative that the subsequent adjusted boundary 160 or 160a is more accurate than the initial boundary 148 or a previous adjusted boundary 160 or 160a, to which it is compared. Similarly, a negative comparison is indicative that the subsequent adjusted boundary 160 or 160a is less accurate than the initial boundary 148 or a previous adjusted boundary 160 or 160a, to which it is compared. Additional embodiments may also be provided with a neutral comparison which is indicative that the subsequent adjusted boundary 160 or 160a is more accurate than the initial boundary 148 or a previous adjusted boundary 160 or 160a, to which it is compared, but is less accurate than desired, such that the process of adjustment and comparison should be repeated to achieve a more accurate result. In response to a neutral comparison, the initial boundary 148 may be replaced with the adjusted boundary 160 or 160a, such that a subsequent initial boundary 160 or 160a will be compared to the replaced initial boundary 148.

In one preferred embodiment, the initial boundary 148 is iteratively adjusted for a number of incremental increases and decreases in the volume of the tumor 104 to identify a number of adjusted boundaries 160 and 160a, respectively. For example, the initial boundary 148 may be iteratively adjusted to increase the volume within the initial boundary by 5%, 10%, 15%, and so on to identify an equivalent number of corresponding adjusted boundaries 160; and the initial boundary 148 may be iteratively adjusted to decrease the volume within the initial boundary 148 by 5%, 10%, 15%, and so on, to identify an equivalent number of corresponding adjusted boundaries 160a.

The iterative adjustments are repeated for a pre-determined number of iterations, for example, to identify the change in the at least one parameter for adjusted boundaries 160 and 160a between the range of volume increases and decreases between 100% and −90%, respectively. The at least one parameter, such as k₁₂, is then analyzed for each of the adjusted boundaries 160 and 160a and compared to the at least one parameter for the initial boundary 148. The at least one parameter for each of the adjusted boundaries 160 and 160a is then be plotted or compared, in absolute or normalized fashion, against the respective region change for each of the adjusted boundaries 160 and 160a, as well as the initial boundary 148; and the data modeled manually or by a curve-fitting algorithm to obtain a curve indicative of the change in the at least one parameter relative to the region change for each of the boundaries 148, 160, and 160a. As will be appreciated by those skilled in the art, the resulting curve can then be analyzed by a user or by the computer apparatus 18 so as to identify any sharp changes in slope or other deviations indicative of accurate limits of the tumor 148.

In another embodiment, the one or more adjusted boundaries 160a are compared to the one or more adjusted boundaries 160, so as to make the process more sensitive to changes in tissue characteristics near the limits of the tumor 104. For example, since the center of the tumor 104 an be ascertained with relative certainty, and because calculating the at least one parameter for the entire region within the initial boundary 148 includes tissue of relatively known properties; excluding the region within the inner adjusted boundary 160a and only calculating the at least one parameter between the adjusted boundary 160a and the adjusted boundary 160, makes the process more sensitive to changes in tissue characteristics between iterative adjusted boundaries 160. Specifically, excluding the volume of tissue within the adjusted boundary 160a reduces the amount of tissue of known characteristics over which the at least one parameter is analyzed and averaged. Thus, when non-cancerous, or otherwise differentiable tissues are included in an outer adjusted boundary 160, the resulting difference in the at least one parameter will be averaged over a much smaller volume of tissue, and the change will be more pronounced and noticeable.

In practice any one or more, or combination of, the above methods, including simple manual delineation, may be used to identify an accurate boundary, e.g. 148,160, or 160a, of the tumor 104. Once the tumor 104, or other region of interest 104, is identified, the computer apparatus 18 preferably implements known numerical methods or other algorithms to determine a centroid C, which is preferably the center of volume or center of mass, of the tumor 104. The centroid C may also be manually selected, for example, by a user, in any methodical or arbitrary fashion. Similarly, multiple centroids C may be selected for a single tumor 104, such as for multiple sections or partitions of a tumor; as well as for multiple tumors 104 within an image. Preferably, the axis 144 is then, either manually or by the computer apparatus 18, adjusted to intersect the centroid C, while maintaining some alignment, or other relation or reference to, one or more biological landmarks, in this example, the uterine stripe 112, and/or other portions of the uterus 108 (FIGS. 2 and 3).

Referring now to FIG. 5, an enlarged side view of the tumor 104 of FIGS. 2, 3, and 4 is depicted. As shown, the tumor 104 is preferably divided into a plurality of segments, W1, W2 (not shown), W3, W4, W5, W6, W7, and W8; with each of the segments W1-W8 positionally referenced to a biological landmark of the organism 34 (FIG. 1), such as, in this example, the uterine stripe 112, or other portion of the uterus 108, as discussed above. The segments W1-W8 may be qualitatively or quantitatively positionally referenced to the biological landmark, and/or may be directly or indirectly positionally referenced to the biological landmark. For example, because the axis 144 is positionally referenced to the biological landmark, the wedges W1-W8 may be positionally referenced to the biological landmark indirectly, by way of the axis 144 and/or the centroid C.

In one preferred embodiment, the tumor 104 is divided into six equiangular wedges W3, W4, W5, W6, W7, and W8, by cut planes 200, 204, and 208; and is further divided to include two conical segments W1 and W2 projecting outward on each side of the tumor 104 from the centroid C. Thus, only segment W1 is shown in the side view of FIG. 5, but segment W2 projects outward toward the opposite side in a manner equivalent to that of segment W1. In another embodiment (not shown), a tumor or other region of interest may be divided into one or more radially-defined layers, for example, similar to the layers of onion.

The positions of the cut planes 200, 204, and 208 are preferably selected in relation to the biological landmark. Specifically, the tumor 104 shown in the figures is referenced to the uterus 108. One known characteristic of the uterus 108 is that, generally, there is greater circulation toward the corpus 120 than toward the cervix 116. Therefore, the cut planes W3-W8 are oriented to as to optimally reflect any resulting heterogeneity within the tumor 104. Specifically, three wedges W3, W4, and W8 lie on the side of cut plane 204 facing the corpus 120 of the uterus 108, and three wedges W5, W6, and W7 lie on the side of the cut plane 204 facing the uterus. As shown, this orientation is achieved by orienting cut plane 200 at a thirty degree angle from the axis 144, and orienting cut planes 204 and 208 at sixty degree angular increments from one another and from cut plane 200. All three cut planes 200, 204, and 208 are perpendicular to a plane (not shown) that bisects the human torso shown in FIG. 2.

The conical segments W1 and W2 (not shown) are created by protecting a hexagonal cone outward from the centroid C. The sides of the conical segments W1 and W2 are preferably disposed at an equal angle from an axis parallel to all three cut planes 200, 204, and 208, and intersecting the centroid C. This angle may be predefined, selected by a user, automatically calculated to obtain conical segments W1 and W2 of approximately equivalent volume to the wedge segments W3-W8, or in any other suitable manner. In the case of the tumor 104 lying in the uterus 108, as shown, the conical segments W1 and W2 have been found to demonstrate very little variance in perfusion, and therefore, may be omitted entirely without significant detriment.

In other embodiments, or as advantageous for particular applications of the present invention, a tumor or other region of interest 104 may be divided into any number of wedges, for example 4, 5, 8, or the like, and may be spaced in an equiangular fashion, as shown, or may be disposed at, or defined by, varying or unequal angular locations. Similarly, the tumor or other region of interest 104 may be divided into segments of any shape, size, number, or the like, so long as they are positionally referenced to a biological landmark, such as, in this example, the uterine stripe 112, or other portion of the uterus 108, as discussed above.

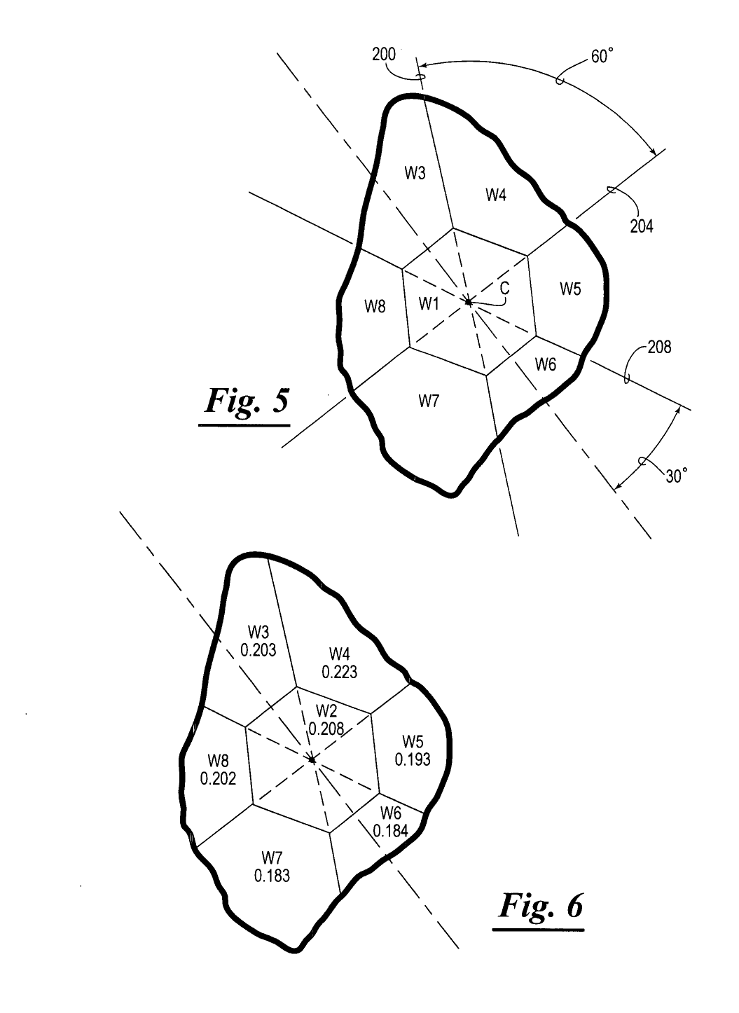

Once the tumor 104 is divided into the plurality of segments W1-W8, either manually by a user via input device 46 (FIG. 1), or by the computer apparatus 18 (FIG. 1), the computer apparatus 18 preferably registers the plurality of segments W1-W2 of the tissue in the image 100 (FIG. 2). The computer apparatus 18, then analyzes at least one parameter for at least one, and preferably all, of the plurality of segments W1-W8. In the case of a tumor 104, the computer apparatus preferably analyzes at least one factor indicative of tumor vascularity, perfusion, or the like, such as are well-known in the use of DCE-MRI technology. For example, as described above, the relative contrast between voxels in the preferred three-dimensional image 100 can be analyzed to indicate relative perfusion rates, and thus vascularity, within each of the segments W1-W8. FIG. 6 depicts an exemplary mean signal response distribution for the tumor 104, obtained using known DCE-MRI techniques. The segments W3, W4, and W8 with relatively higher values have absorbed more contrast agent, and can therefore be determined to be relatively more vascular and have resulting higher rates of perfusion, than the segments with relatively lower values W5, W6, W7.

In the preferred embodiment, the at least one parameter is calculated individually for each of the voxels and the at least one parameter is then aggregated for all of the voxels within an individual segment, for example, segment W3. The at least one parameter can be aggregated for a given segment by any suitable numerical method or algorithm. For example, a parameter may be averaged over all of the voxels in segment W3, may have disparate values removed and the remaining voxels averaged, may be curve-fit to reduce the error by attempting to eliminate disparate values, or may be aggregated over the segment W3 by any other suitable method. In the interest of time and efficiency, the analysis of the at least one parameter for the segments W1-W3 is preferably completed by a program or algorithm of the computer apparatus 18. In other embodiments, the at least one parameter may be aggregated before being analyzed or may be analyzed and aggregated in a single step. For example, the computer apparatus 18 may be programmed to blur, or graphically average, the colors or gray shades of the voxels in a segment into a single color or gray shade, which may then be analyzed by the computer apparatus 18 over the entire segment.

In other embodiments, the at least one parameter may be a qualitative parameter, such that the analysis may be completed by a user. For example, the computer apparatus 18 can be programmed to blur, or graphically average, the colors or gray shades of the voxels of a segment into a single color or gray shade. The resulting color or gray shade could then be output to a user on a screen or printed sheet, such that the user could manually analyze the at least one parameter by comparing the color or gray shade to a reference chart or the like of known colors or gray shades.

Once the at least one parameter has been analyzed, preferably for each of the segments W1-W8, the computer apparatus 18 implements suitable algorithms to determine a treatment pattern for the tumor 104. More specifically, the computer apparatus 18 preferably determines an optimal or desirable distribution for treatment of each of the segments W1-W8. In some embodiments or applications, it may be desirable to treat only a portion of a segment, or to treat only a portion of the segments W1-W8, and thus, to develop a treatment pattern indicative of such.

As an illustration, there is generally a limit on the amount of radiation therapy (RT) it is safe to treat an individual with. For example, if it is determined that an individual can only safely absorb 50 units of RT, the computer apparatus 18 is programmed to determine a treatment pattern to maximize the likelihood of success, i.e. killing the tumor tissue. For the mean signal response distribution of FIG. 6, the computer apparatus is programmed to distribute the 50 units of RT among the segments W1-W8 in accordance with their relative vascularity. Because it is known that RT is most effective in tissue with higher vascularity and rates of perfusion, the segments W3, W4, and W8 are preferably treated with relatively more RT.

The computer apparatus 18 can thus distribute the 50 units of RT in relative proportion to the mean signal response values relative to the sum of the mean signal response values for all of the segments W1-W8. Assuming segment W1 and segment W2 have identical values, this weighted distribution results in segment W1 being targeted with approximately 6.5 units of RT, W2 with 6.5 units, W3 with 6.3 units, W4 with 7.0 units, W5 with 6.0 units, W6 with 5.7 units, W7 with 5.7 units, and W8 with 6.3 units. In other embodiments, the computer 18 may be programmed to omit segments, such as segments W6 and W7, that are below a certain threshold, for example 1.9, from RT treatment so as to distribute the entire the entire 50 units of RT among segments W1-W5 and W8 that the RT will be more effective in treating. Preferably, the computer apparatus 18 would then provide a treatment pattern including at least one other type of treatment for segments W6 and W7, such as targeted chemotherapy or the like.

The treatment pattern may also be determined in any other suitable manner as well. In one embodiment, the treatment pattern is determined in relation to the position of the segment relative to the biological landmark. For example, if a segment is located near a particularly sensitive organ or nerve, the segment may be treated at a relatively lower level, or omitted entirely from a particular type of treatment. In another embodiment, the treatment pattern is determined in relation to both the at least one parameter and the position of the segment relative to the biological landmark. The treatment pattern may also be determined with any suitable algorithm, curve, or model. For example, the predicted response of a particular segment can be used to determine the appropriate type or types of treatment, relative amount of treatment, duration of treatment, or the like, for the particular segment.

Although the treatment pattern is described above as being determined by the computer apparatus 18 (FIG. 1), the treatment pattern may also be determined by the treatment apparatus 22. For example, the computer apparatus 18 can output data indicative of the analysis of the at least one parameter to the treatment apparatus 22, such that the treatment apparatus 22 determines the treatment pattern. Similarly, the computer apparatus 18 may output data indicative of the analysis of the at least one parameter to a user, such that the user determines the treatment apparatus manually, or with a remote computer (not shown).

Once a treatment pattern is determined, the treatment apparatus 22 (FIG. 1) delivers at least one type of therapy in accordance with the treatment pattern. Although the treatment apparatus 22 is described above as preferably an RT device, other embodiments of the treatment apparatus 22 may deliver any suitable type of therapy or combination of therapies. For example, the treatment apparatus 22 may be adapted to deliver radiation therapy (RT) and chemotherapy.

Although the methods above are generally described as being implemented by the computer apparatus 18, programmed to perform the various functions, it should also be understood that the methods may be implemented independently of the computer apparatus 18, and even independent of the system 10. Other embodiments of the system 10 may comprises a plurality of computer apparatuses 18, such that the various programming, functions, storage, may be distributed among two or more computer apparatuses 18.

### 3. Exemplary Studies and Results

In a first study, a semi-automated methodology was developed and implemented to investigate and evaluate the relationship between projected tumor sizes utilizing DCE-MRI pharmacokinetics and standard ratio measures (SRM). Large variations in tumor delineations have previously been demonstrated between individuals, such as diagnostic radiologists and radiation oncologists, completing manual tumor delineations for cervical cancer. The semi-automated methodology developed is capable of projecting the effect of size variations on the generated pharmacokinetic parameters based on an initial manual delineation for a given a tumor or patient set to assist in evaluating and improving the accuracy with which a tumor is identified.

This first study was completed as follows. DCE-MRI data from approximately 300 cervical cancer imaging studies over about a ten year period were obtained. Typically, each of the patients was evaluated at one pre- and two post-radiotherapy time points. The DCE-MRI protocols varied somewhat over the ten-year period, but were all generally consistent with the contemporary standards at the time they were performed. The most common protocol was DCE-MRI data acquired during bolus injection with 10 sagittal time frames: TE=5.0 ms, TR=12.0 ms, FA=300, FOV=25×40 cm, matrix=128×256, and number of partitions=12. The pharmacokinetic analysis was performed on a selected subset of 15 pre-therapy cases where it was possible to assess the Arterial Input Function from the Illiac Artery on a patient-by-patient basis.

The k₁₂ parameter was calculated for each of the tumors within the initial, manually-delineated boundary. The initial boundaries for each of the tumors was then adjusted with an automated three-dimensional morphological filter to increase the volume of the delineated tumor by a known percentage of the volume within the initial boundary, i.e. increased by 5%, 10%, 15%, and so on. For each of these volume increments, the k₁₂ parameter was calculated and the standard relative measure registered, so as to track the changes in the pharmacokinetic parameter due to volume changes and thereby provide an indication of the accuracy of the initial and adjusted boundaries. The initial boundary was then adjusted with the automated three-dimensional morphological filter to decrease the volume of the delineated tumor by a known percentage of the volume within the initial boundary, i.e. decreased by 5%, 10%, 15%, and so on. Again, for each of these volume decrements, the k₁₂ parameter was calculated and the standard relative measure registered, so as to track the changes in the pharmacokinetic parameter due to volume changes and thereby provide an indication of the accuracy of the initial and adjusted boundaries.

In summary, the results were as follows. The pharmacokinetic parameter k₁₂ typically varied less than 5% for volume changes as large as 70%. Similar results were witnessed on other pharmacokinetic parameters, such as k₂₁ and amplitude, as well. Signal instability begins to creep into the pharmacokinetic parameters for volume changes greater than 75%. The standard relative measures (SRM) varied over patients, but generally remained less than 15% for volume changes of up to 90%. Further, SRM remained relatively stable even for larger volume changes, i.e. greater than 100%.

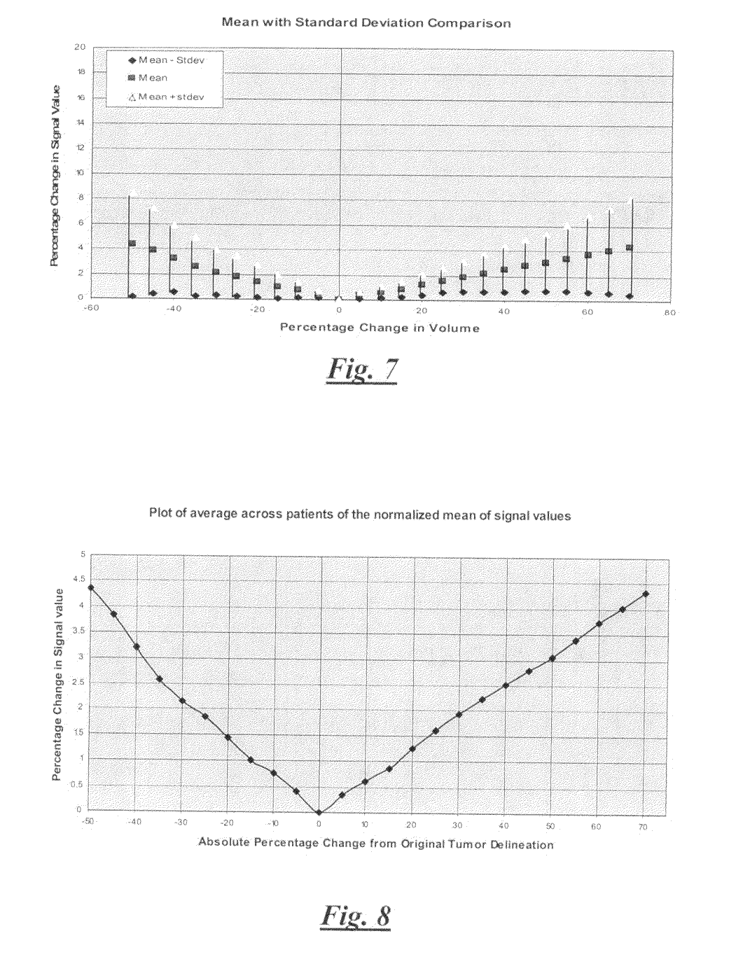

More detailed results of this first study are presented in FIGS. 7-10. FIG. 7 depicts the percentage change in signal value as a function of the percentage change in volume, as well as one standard deviation above and below each value. FIG. 8 is a direct plot of the percentage change in signal value as a function of the absolute percentage change from the original tumor delineation.

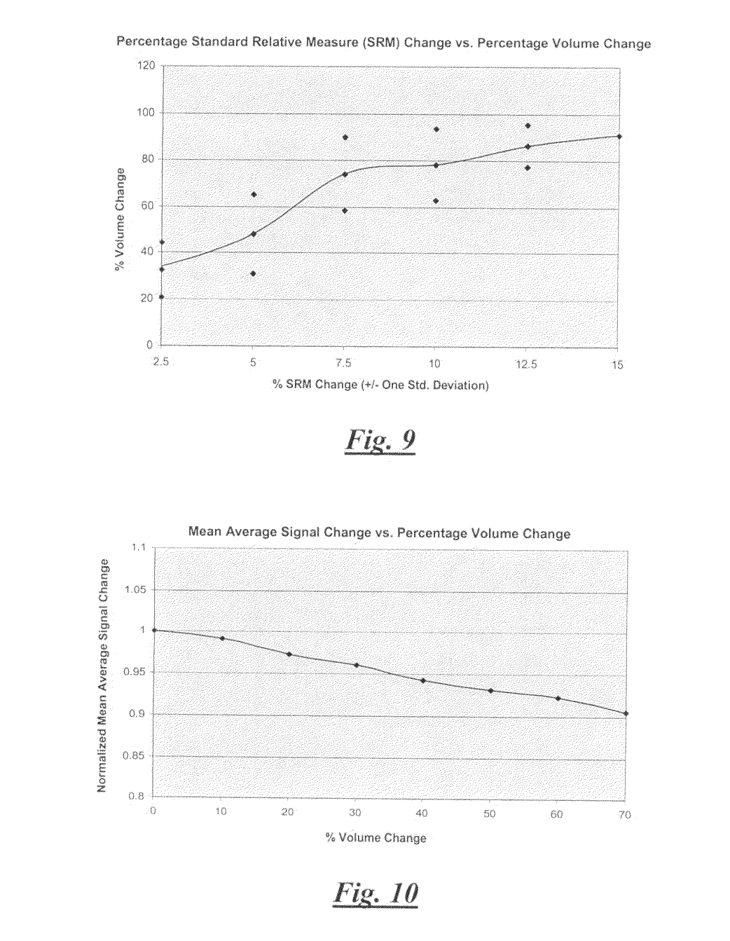

FIG. 9 depicts the percentage volume change as a function of the percentage SRM change. Along with the percentage SRM change, one standard deviation, above and below, is depicted as well. FIG. 10 depicts the mean average signal change across patients relative to the percentage volume change between the initial boundary and the adjusted boundaries. As will be appreciated by those skilled in the art, the mean average signal change has been normalized to the value of the initial signal.

In a second study, tumors were referenced to a biological landmark, segmented, and analyzed to evaluate the heterogeneity within the tumors, especially relative to the biological landmark. DCE-MRI data was obtained and evaluated for 18 cervical cancer patients prior to radiation therapy. MRI images were captured with a Siemens MAGNETRON Vision 1.5T, that included a T2 Turbo Spin Echo (T2-TSE), with the following parameters: TE=125 ms, TR=5 s, FOV=25×40 cm, matrix=192×256. DCE-MRI images were captured during bolus injection with 10 time frames of sagittal ST=8 mm, TE=5.0 ms, TR=12.0 ms, FA=30°, FOV=25×40 cm, matrix=138×256, and number of partitions=14. The T2-TSE and DCE-MRI images were matched spatially using standard sequence copy of the Vision 1.5T. Contrast injection was performed by an MRI-compatible power injector at a rate of 5 cc/s using Prohance™, available from Bracco, Princeton, N.J., and timed to occur after the second time frame.

Tumors and uterine images were manually delineated for each of the 18 patients on the T2-TSE images by a physician. Manual delineation was performed without visualization of the DCE data. Regions of interest (ROI) were then transferred to the DCE-MRI images for RSI analysis.

Each tumor 104 (FIG. 2) was sectioned into eight segments, as described above and depicted in FIG. 5. As also described above, the tumor 104 was segmented in relation to the uterine stripe 112, and the spatial orientation of the uterus 108. The tumor perfusion was estimate by relative signal intensity (RSI), which is defined as the ratio of the plateau post-injection signal intensity (SI) at 75 seconds post-injection, divided by the pre-contrast SI on a pixel-by-pixel basis. Perfusion in each of the eight segments W1-W8 of the tumor 104 was estimated by the mean RSI within each segment. Statistical differences among the various regions were then computed from RSI distributions within each region for cervical cancer patients pre-radiotherapy.

A repeated-measures analysis of variance (ANOVA) design was used to determine if significant differences existed among the eight segments W1-W8 relative to the uterus 108. In addition, a planned comparison contrast between the segments closest to the corpus 120 of the uterus 108 and segments closer to the cervix 116 was performed. Mean values of RSI differences were calculated for each segment and compared. Next, a preplanned comparison set (0, 0, −1/3, −⅓, ⅓, ⅓) was evaluated corresponding to a comparison of segments closest to the corpus 120 with segments closes to the cervix 116. A second contrast set (−1, 1, 0, 0, 0, 0, 0, 0, 0) was then used to evaluate the differences between the left and right segments W1 and W2. All data were evaluated using analysis software available from SAS, Cary, N.C.

Significant differences between the eight segments W1-W8 were found via the repeated-measures ANOVA design, that produced and F-value=18.37 with DOF(7,119) such that p<0.0001 on the pre-radiation treatment data. In addition, the pre-planned comparison between the segments W3, W4, and W8 closest to the corpus and the segments W5, W6, and W7 closest to the cervix demonstrated significant differences, as illustrated in FIG. 6, with t-value=3.19 and p<0.002. However, no significant differences were discovered between the left and right segments W1 and W2 (a=0.05).

Overall, the tests indicated and illustrated significant statistical differences between the RSI values of the eight segments W1-W8. The differences indicate significant variations in contrast uptake, and therefore vascularity, between the various segments. Thus, the portion nearest the corpus 120 appeared to exhibit newer and/or more active pathogenesis with ongoing angiogenesis and greater blood flow.

From the above description, it is clear that the present invention is well adapted to carry out the objects and to attain the advantages mentioned herein, as well as those inherent in the invention. While presently preferred embodiments of the invention have been described for purposes of this disclosure, it will be understood that numerous changes my be made which will readily suggest themselves to those skilled in the art and which are accomplished in the spirit of the invention disclosed and as defined in the appended claims.

What is claimed is:

1. An image analysis system comprising:
a computer apparatus programmed to access at least one image of tissue within a living organism and to register a plurality of segments of a region of interest of the tissue, the plurality of segments divided relative to a biological landmark of the living organism and each of the plurality of segments positionally referenced to the biological landmark, the computer apparatus further programmed to analyze at least one parameter for at least one of the plurality of segments.

2. The image analysis system of claim 1, wherein the at least one image comprises a plurality of images.

3. The image analysis system of claim 2, wherein the plurality of images are taken at known time points.

4. The image analysis system of claim 1, wherein at least one of the plurality of segments is wedge-shaped.

5. The image analysis system of claim 1, wherein at least a portion of the plurality of segments are arranged about at least one centroid of the region of interest.

6. The image analysis system of claim 5, wherein at least one of the plurality of segments is radially-defined about the at least one centroid.

7. The image analysis system of claim 1, wherein the at least one parameter is selected from the group consisting of: k₁₂, k₂₁, amplitude, relative signal intensity, and pharmacokinetic parameters.

8. The image analysis system of claim 1, wherein the at least one image includes a plurality of pixels.

9. The image analysis system of claim 8, wherein the computer apparatus analyzes the at least one parameter for the at least one segment by analyzing the at least one parameter for each of the pixels in the at least one segment and aggregating the at least one parameter for at least a portion of the pixels in the at least one segment.

10. The image analysis system of claim 9, wherein the computer apparatus analyzes the at least one parameter for the at least one segment by aggregating at least a portion of the pixels in the at least one segment and analyzing the at least one parameter for the aggregated pixels.

11. The image analysis system of claim 1, wherein the at least one image is a three-dimensional image including a plurality of voxels.

12. The image analysis system of claim 11, wherein the computer apparatus analyzes the at least one parameter for the at least one segment by analyzing the at least one parameter for each of the voxels in the at least one segment and aggregating the at least one parameter for at least a portion of the voxels in the at least one segment.

13. The image analysis system of claim 11, wherein the computer apparatus analyzes the at least one parameter for the at least one segment by aggregating at least a portion of the voxels in the at least one segment and analyzing the at least one parameter for the aggregated voxels.

14. The image analysis system of claim 1, further comprising an image recording apparatus for capturing the at least one image.

15. The image analysis system of claim 14, wherein the at least one image includes a plurality of pixels.

16. The image analysis system of claim 15, wherein the computer apparatus analyzes the at least one parameter for the at least one segment by analyzing the at least one parameter for each of the pixels in the at least one segment and aggregating the at least one parameter for at least a portion of the pixels in the at least one segment.

17. The image analysis system of claim 16, wherein the computer apparatus analyzes the at least one parameter for the at least one segment by aggregating at least a portion of the pixels in the at least one segment and analyzing the at least one parameter for the aggregated pixels.

18. The image analysis system of claim 14, wherein the at least one image is a three-dimensional image including a plurality of voxels.

19. The image analysis system of claim 18, wherein the computer apparatus analyzes the at least one parameter for the at least one segment by analyzing the at least one parameter for each of the voxels in the at least one segment and aggregating the at least one parameter for at least a portion of the voxels in the at least one segment.

20. The image analysis system of claim 18, wherein the computer apparatus analyzes the at least one parameter for the at least one segment by aggregating at least a portion of the voxels in the at least one segment and analyzing the at least one parameter for the aggregated voxels.

21. The image analysis system of claim 14, wherein the image recording apparatus is selected from the group consisting of: a magnetic resonance imaging device, an x-ray device, a nuclear imaging device, a computed tomographic imaging device, an ultrasonic imaging device, an MRI spectroscopy device, a positron emission tomographic imaging device, and a hybrid device.

22. The image analysis system of claim 1, further comprising:
a treatment apparatus for delivering at least one type of therapy to at least a portion of at least one of the plurality of segments in relation to the position of the at least one segment relative to the biological landmark.

23. The image analysis system of claim 22, wherein the type of therapy is selected from the group consisting of: radiation therapy, chemotherapy, drug therapy, surgical therapy, nuclear therapy, brachytherapy, heat therapy, laser therapy, and ultrasonic therapy.

24. The image analysis system of claim 23, wherein the treatment apparatus delivers the at least one type of therapy to at least a portion of at least one of the plurality of segments in relation to the at least one parameter.

25. The image analysis system of claim 22, further comprising an image recording apparatus for capturing the at least one image.

26. The image analysis system of claim 25, wherein the image recording apparatus is selected from the group consisting of: a magnetic resonance imaging device, an x-ray device, a nuclear imaging device, a computed tomographic imaging device, an ultrasonic imaging device, an MRI spectroscopy device, a positron emission tomographic imaging device, and a hybrid device.

27. The image analysis system of claim 1, further comprising:
a treatment apparatus for delivering at least one type of therapy to at least a portion of at least one of the plurality of segments in relation to the at least one parameter.

28. The image analysis system of claim 27, wherein the type of therapy is selected from the group consisting of: radiation therapy, chemotherapy, drug therapy, surgical therapy, nuclear therapy, brachytherapy, heat therapy, laser therapy, and ultrasonic therapy.

29. The image analysis system of claim 27, further comprising an image recording apparatus for capturing the at least one image.

30. The image analysis system of claim 29, wherein the image recording apparatus is selected from the group consisting of: a magnetic resonance imaging device, an x-ray device, a nuclear imaging device, a computed tomographic imaging device, an ultrasonic imaging device, an MRI spectroscopy device, a positron emission tomographic imaging device, and a hybrid device.

31. A method of analyzing at least one image, the method comprising the steps of:
accessing at least one image of tissue within a living organism;
identifying a region of interest of the tissue;
dividing the region of interest into a plurality of segments relative to a biological landmark of the living organism;
positionally referencing each of the plurality of segments to the biological landmark; and,
analyzing at least one parameter for at least one of the plurality of segments.

32. A method of treating a living organism, comprising the steps of:
accessing at least one image of tissue within a living organism;
identifying a region of interest of the tissue;
dividing the region of interest into a plurality of segments;
positionally referencing each of the plurality of segments to a biological landmark of the living organism;
delivering at least one type of therapy to at least a portion of at least one of the plurality of segments in relation to the position of the at least one segment relative to the biological landmark.

33. The method of claim 32, wherein the region of interest is divided into the plurality of segments relative to the biological landmark.

34. The method of claim 32, further comprising the step of analyzing at least one parameter for at least one of the plurality of segments.

35. The method of claim 34, wherein the at least one type of therapy is delivered to the at least one segment in relation to the at least one parameter.

36. The method of claim 32, wherein the type of therapy is selected from the group consisting of: radiation therapy, chemotherapy, drug therapy, surgical therapy, nuclear therapy, brachytherapy, heat therapy, laser therapy, and ultrasonic therapy.

37. A method of treating a living organism, comprising the steps of:
accessing at least one image of tissue within a living organism;
identifying a region of interest of the tissue;
dividing the region of interest into a plurality of segments relative to a biological landmark of the living organism;
positionally referencing each of the plurality of segments to the biological landmark;
analyzing at least one parameter for at least one of the plurality of segments; and,
delivering at least one type of therapy to at least a portion of at least one of the plurality of segments in relation to the at least one parameter.

38. The method of claim 37, wherein the type of therapy is selected from the group consisting of: radiation therapy, chemotherapy, drug therapy, surgical therapy, nuclear therapy, brachytherapy, heat therapy, laser therapy, and ultrasonic therapy.

39. A method of operating an image analysis system including a computer apparatus, the method comprising:
operating the computer system to access at least one image of tissue within a living organism and to register a plurality of segments of a region of interest of the tissue, the plurality of segments divided relative to a biological landmark of the living organism and each of the plurality of segments positionally referenced to the biological landmark; and,
operating the computer apparatus to analyze at least one parameter for at least one of the plurality of segments.

40. The method of claim 39, wherein the image analysis system further includes an image recording apparatus, the method further comprising the step of operating the image recording apparatus to capture the at least one image prior to operating the computer apparatus to access the at least one image.

41. A method of operating an image analysis system including a computer apparatus and a treatment apparatus, the method comprising the steps of:
operating the computer apparatus to access at least one image of tissue within a living organism and to register a plurality of segments of a region of interest of the tissue, each of the plurality of segments positionally referenced to a biological landmark of the living organism;
operating the computer apparatus to analyze at least one parameter for at least one of the plurality of segments; and,
operating the treatment apparatus to deliver at least one type of therapy to at least a portion of at least one of the plurality of segments in relation to the position of the at least one segment relative to the biological landmark.

42. The method of claim 41, wherein the plurality of segments is divided relative to the biological landmark.

43. The method of claim 41, further comprising the step of operating the computer to analyze at least one parameter for at least one of the plurality of segments.

44. The method of claim 43, wherein the at least one type of therapy is delivered to the at least one segment in relation to the at least one parameter.

45. The method of claim 44, wherein The image analysis system further includes an image recording apparatus, the method further comprising the step of operating the image recording apparatus to capture the at least one image prior to operating the computer apparatus to access the at least one image.

46. A method of operating an image analysis system having a computer apparatus and a treatment apparatus, the method comprising the steps of:
operating the computer apparatus to access at least one image of tissue within a living organism and to register a plurality of segments of a region of interest of the tissue, the plurality of segments divided relative to a biological landmark of the living organism, each of the plurality of segments positionally referenced to the biological landmark;
operating the computer apparatus to analyze at least one parameter for at least one of the plurality of segments; and,
operating the treatment apparatus to deliver at least one type of therapy to at least a portion of at least one of the plurality of segments in relation to the at least one parameter.

47. The method of claim 46, wherein The image analysis system further includes an image recording apparatus and, the method further comprises the step of operating the image recording apparatus to capture the at least one image prior to operating the computer apparatus to access the at least one image.

48. A method of identifying a region of interest in an image, comprising the steps of:
accessing at least one image of tissue within a living organism;
identifying an initial boundary of a region of interest of the tissue;
analyzing at least one parameter for the tissue within the initial boundary;
performing an analysis of the initial boundary, comprising the steps of:
adjusting the initial boundary to identify an adjusted boundary;
calculating a region difference indicative of the change between the initial boundary and the adjusted boundary;
analyzing the at least one parameter for the tissue within the adjusted boundary;
analyzing a parameter difference indicative of the change between the at least one parameter for the initial boundary and the at least one parameter for the adjusted boundary;
comparing the parameter difference to a reference;
repeating the step of performing an analysis of the initial boundary, responsive to a negative comparison;
replacing the initial boundary with the adjusted boundary, responsive to a positive comparison.
